(19) United States
(12) Patent Application Publication
(10) Pub. No.: US 2021/0231783 A1
(43) Pub. Date: Jul. 29, 2021

(54) MEASUREMENT-DISTANCE CORRECTION METHOD, DISTANCE MEASURING DEVICE, AND DISTANCE MEASURING SYSTEM

(71) Applicant: Hitachi-LG Data Storage, Inc., Tokyo (JP)

(72) Inventors: Katsumi ITO, Tokyo (JP); Seiji INABA, Tokyo (JP)

(21) Appl. No.: 17/086,525

(22) Filed: Nov. 2, 2020

(30) Foreign Application Priority Data
Jan. 23, 2020 (JP) 2020-008974

(51) Int. Cl. G01S 7/4865; G01S 7/497; G01S 17/10

(52) U.S. Cl. CPC G01S 7/4865; G01S 17/10; G01S 7/497

(57) ABSTRACT

As a preparatory step for correction, a measurement sample is placed such that a distance of the measurement sample from the distance measuring device becomes a set value L1, a distance to the measurement sample 3′ is measured by the distance measuring device, and a measurement value L2 is obtained. The measurement value L2 corresponding to a plurality of values of the set value L1 is acquired, while the set value L1 is changed to the plurality of values, and a correction formula for converting the measurement value L2 to the set value L1 is created on a basis of a relationship between the acquired set value L1 and measurement value L2. As an actual measurement step, a distance (actual measurement value x) to the target object 3 measured by the distance measuring device is corrected in accordance with the correction formula, and a measurement-distance corrected value y is calculated.

### CLAIM OF PRIORITY

The present application claims priority from Japanese patent application serial No. JP 2020-8974, filed on Jan. 23, 2020, the content of which is hereby incorporated by reference into this application.

### BACKGROUND OF THE INVENTION

### (1) Field of the Invention

The present invention relates to a measurement-distance correction method for a distance measuring device that measures the distance to a target object on the basis of the time of flight of light.

### (2) Description of the Related Art

There are known distance measuring devices that use the method of measuring the distance to a target object on the basis of the time of flight (hereinafter, TOF: time of flight) of light (hereinafter, also called TOF devices). By displaying distance data acquired by the TOF devices as two-dimensional distance images, and tracing temporal changes of the distance data, travel routes (lines of movement) of persons in a room can be determined, for example.

According to the principle of the TOF devices, irradiation light emitted from a light source is reflected off a target object, and time (optical path length) it takes for the irradiation light to return to a light receiving section is measured to calculate the distance to the target object. Therefore, in a case where the TOF devices are used in an environment where highly reflective materials are used for the surrounding wall, floor, or the like, unnecessary reflection from the wall, floor, or the like makes the optical path length appear to be longer. This is called the multipath phenomenon, and as a result of it, measurement values larger than actual distances are generated by measurement, and distance errors occur.

As a method of correcting distance errors that occur due to the multipath phenomenon, there is a technology described in WO2019/188348, for example. A distance information acquiring device described in WO2019/188348 is configured to compare a sequence of actual reception-light signals acquired by a solid-state imaging element (light receiving section) with reference data that has been created in advance as a model of reception-light signals in a multipath-free environment, to determine whether or not there is multipath in accordance with whether or not results of the comparison show that there are differences, and calculate a correction coefficient in accordance with the results of the comparison indicating the ratio between the sequence of reception signals, and the reference data.

### SUMMARY OF THE INVENTION

In a correction method described in WO2019/188348, changes (polygonal line) of a reception-light amount (accumulation amount) in an exposure period are determined while the exposure timing is shifted by a predetermined length of time, and are compared with changes (polygonal line of the reference data) of a reception-light amount in the multipath-free environment, to thereby calculate a correction coefficient from the ratio between both accumulation amounts at predetermined exposure timings. Accordingly, it is anticipated that the load of processing for correction such as the control of the exposure timing or the acquisition of temporal changes of the reception-light amounts increases to complicate the device configuration, and the device cost also increases. Furthermore, the degree of the influence of multipath depends on a measurement environment whose characteristics depend on its wall, floor, or the like, and the different correction coefficients should be used for different lengths of measurement distances, that is, for short-distance measurement and long-distance measurement. The technology of WO2019/188348 does not particularly take into consideration calculations of correction coefficients in accordance with the lengths of measurement distances.

An object of the present invention is to provide a measurement-distance correction method, a distance measuring device, and a distance measuring system that make it possible to more simply perform a process of correcting distance errors that occur due to the multipath phenomenon in distance measuring devices that use TOF, and appropriately correct measurement distances in accordance with the lengths of the measurement distances.

According to the present invention, a measurement-distance correction method for a distance measuring device that measures a distance to a target object on a basis of time of flight of light includes:

a preparatory step for correction including:
a step of placing a measurement sample such that a distance of the measurement sample from the distance measuring device becomes a set value L1;
a step of measuring a distance to the measurement sample by the distance measuring device, and obtaining a measurement value L2;
a step of acquiring the measurement value L2 corresponding to a plurality of values of the set value L1, while the set value L1 is changed to the plurality of values; and
   a step of creating a correction formula for converting the measurement value L2 to the set value L1 on a basis of a relationship between the acquired set value L1 and measurement value L2.

Next, the measurement-distance correction method includes a step of actual measurement of a distance to the target object including:
a step of measuring the distance to the target object by the distance measuring device, and obtaining an actual measurement value x;
a step of correcting the actual measurement value x in accordance with the correction formula, and calculating a measurement-distance corrected value y; and
a step of outputting the corrected value y.

In addition, according to the present invention, a distance measuring device that measures a distance to a target object on a basis of time of flight of light includes:

a light emitting section that emits irradiation light toward the target object;

a light receiving section that detects reflected light from the target object;

a light-emission control section that controls the light emitting section;

a distance computing section that calculates the distance to the target object on a basis of time of flight of the reflected light detected at the light receiving section; and

a distance correcting section that uses a correction formula, and corrects the distance calculated at the distance computing section.

The correction formula is an approximation formula created in advance for converting a measurement value L2 to a set value L1 on a basis of a relationship between a plurality of values of the set value L1 and a plurality of values of the measurement value L2, the set value L1 being a distance of a measurement sample from the distance measuring device, the measurement value L2 being a measurement value of measurement of a distance to the measurement sample by the distance measuring device.

In addition, according to the present invention, a distance measuring system includes: a distance measuring device that measures a distance to a target object on a basis of time of flight of light; and an external processing device that corrects a measurement distance measured by the distance measuring device.

The distance measuring device has:
a light emitting section that emits irradiation light toward the target object;
   a light receiving section that detects reflected light from the target object;
   a light-emission control section that controls the light emitting section; and
   a distance computing section that calculates the distance to the target object on a basis of time of flight of the reflected light detected at the light receiving section.

The external processing device has: a distance correcting section that uses a correction formula, and corrects the distance calculated at the distance computing section of the distance measuring device.

The correction formula is an approximation formula created in advance for converting a measurement value L2 to a set value L1 on a basis of a relationship between a plurality of values of the set value L1 and a plurality of values of the measurement value L2, the set value L1 being a distance of a measurement sample from the distance measuring device, the measurement value L2 being a measurement value of measurement of a distance to the measurement sample by the distance measuring device.

According to the present invention, it is possible to significantly reduce the processing load for distance correction by distance measuring devices, and to appropriately correct measurement distances in accordance with the lengths of the measurement distances.

### BRIEF DESCRIPTION OF THE DRAWINGS

These and other features, objects and advantages of the present invention will become more apparent from the following description when taken in conjunction with the accompanying drawings wherein:

FIG. 1 is a figure illustrating the configuration of a distance measuring device according to a first embodiment;

FIG. 2 is a figure for explaining the principle of distance measurement by TOF;

FIG. 3 is a figure for explaining the multipath phenomenon;

FIGS. 4A and 4B are figures illustrating an example of a distance error that occurs due to the multipath phenomenon;

FIGS. 5A to 5C are figures for explaining influence of a distance error in line-of-movement measurement;

FIG. 6 is a figure for explaining a distance-error measurement method at a preparatory step;

FIGS. 7A and 7B are figures for explaining an example of creation of formulae for distance error correction;

FIG. 8 is a flowchart illustrating a procedure of distance correction; and

FIG. 9 is a figure illustrating the configuration of a distance measuring system according to a second embodiment.

### DETAILED DESCRIPTION OF THE EMBODIMENT

In the following, embodiments of the present invention are explained in detail with reference to the drawings. It should be noted, however, that the interpretation of the present invention should not be limited to the description contents of the embodiments illustrated below. Those skilled in the art easily understand that specific configurations of the present invention may be modified within the scope not deviating from the idea and gist of the present invention.

In the configuration of the invention explained below, common and identical reference characters are used for identical portions or portions having similar functionalities through different drawings, and overlapping explanation is omitted in some cases.

### First Embodiment

FIG. 1 is a figure illustrating the configuration of a distance measuring device according to a first embodiment. Although distances to a person as a measurement target object are measured in the following examples explained, these are not the sole examples.

A distance measuring device (TOF device) 1 includes: a light emitting section 11 that irradiates a target object with pulsed light from a light source such as a laser diode (LD) or a light emitting diode (LED); a light receiving section 12 that receives, at a CCD sensor, a CMOS sensor, or the like, the pulsed light reflected from the target object; a light-emission control section 13 that controls the light emitting section 11 such that it is turned on or turned off or such that the amount of light it emits is changed; and a distance computing section 14 that computes a distance to the target object from a detection signal (reception-light data) of the light receiving section 12. Furthermore, in the present embodiment, the TOF device 1 includes a distance correcting section 15 that corrects distance data output from the distance computing section 14, and a correction formula 16 to be used for the correction is stored in advance on a memory in the device.

The corrected distance data is sent to an external processing device 2. For example, the external processing device 2 includes a personal computer, generates a distance image by performing a colorization process of changing the hue of each section of a target object on the basis of the distance correction data (image processing operation), and outputs the image to a display which then displays the image (display operation). In addition, by analyzing changes of the position of the target object (a person, etc.) on the basis of the distance data, the locus of travel (line of movement) of the person, or the like can be obtained.

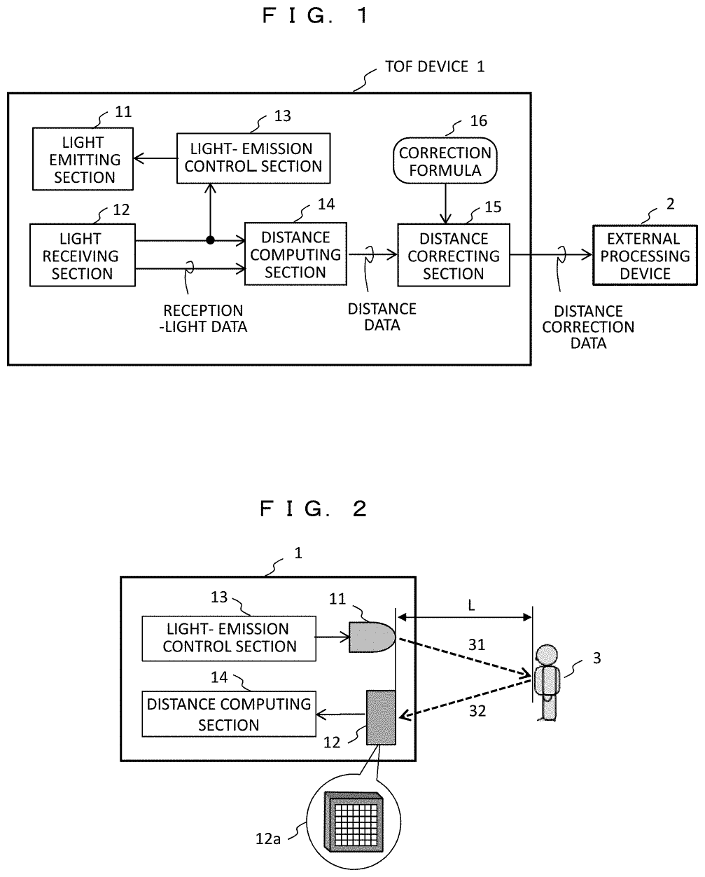

FIG. 2 is a figure for explaining the principle of distance measurement by TOF. A relationship between the TOF device 1 and a target object 3 (e.g. a person) is illustrated. The TOF device 1 has the light emitting section 11 and the light receiving section 12, and emits distance-measurement irradiation light 31 from the light emitting section 11 toward the target object 3. The light receiving section 12 receives, at a two-dimensional sensor 12a such as a CCD, reflected light 32 reflected off the target object 3. The target object 3 is at a position apart from the light emitting section 11 and the light receiving section 12 by a distance L. Here, assuming that the speed of light is c, and the temporal difference between emission of the irradiation light 31 by the light emitting section 11 and reception of the reflected light 32 by the light receiving section 12 is t, the distance L to the target object 3 is determined by L=cxt/2. Note that, instead of using the temporal difference t, in practical distance measurement performed by the distance computing section 14, an irradiation pulse with predetermined intervals is emitted, the pulse is received by the two-dimensional sensor 12a while the timing of the exposure gate of the two-dimensional sensor 12a is varied, and the distance L is calculated from values of reception-light amounts (accumulation amounts) at different timings.

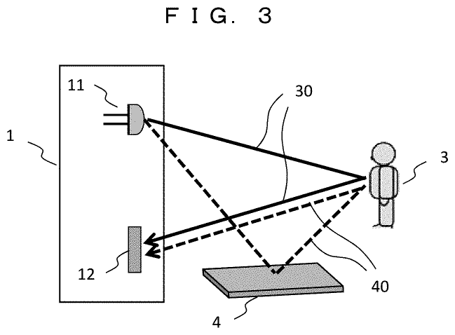

FIG. 3 is a figure for explaining the multipath phenomenon. The irradiation light emitted from the light emitting section 11 is reflected off the target object 3 to return to the light receiving section 12, and normally the path of the reflected light is the shortest optical path illustrated by a solid line 30. The light that travels along this optical path is called here “direct light.” However, in an environment where there is a wall or floor 4 formed by using a highly reflective material, some of the irradiation light is reflected off the wall or floor 4, or the like, and returns to the light receiving section 12 along an optical path illustrated by a broken line 40. This phenomenon is called the “multipath phenomenon,” and the light that travels along this optical path is called here “indirect light.” That is, because the optical paths between the light emitting section 11 and the target object 3 or between the target object 3 and the light receiving section 12 along which the indirect light travels are not the shortest straight lines but are polygonal lines, the optical path 40 of the indirect light becomes longer than the optical path length of the optical path 30 of the direct light. The light receiving section 12 receives a mixture of the direct light and the indirect light, and this becomes a cause of the occurrence of measurement-distance errors at the TOF device.

In a case where the multipath phenomenon has occurred, there is often not only one but a large number of optical paths of the indirect light, and there are also various intensity ratios of the indirect light to the direct light. The light receiving section 12 receives the direct light, and a lot of the indirect light that is delayed relative to the direct light. In the case of an exposure-gate type light receiving section, a reception-light amount detected in a predetermined gate period differs from a true reception-light amount of the direct light (not affected by multipath), and this is observed as a distance error in a distance calculation.

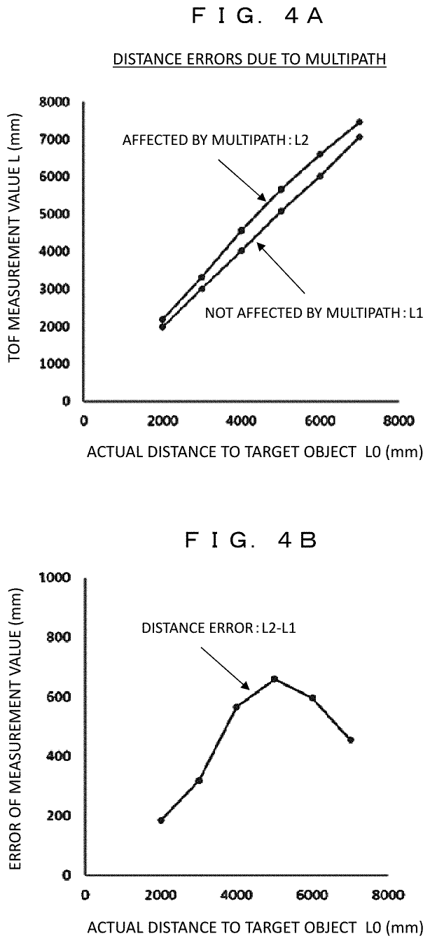

FIGS. 4A and 4B are figures illustrating an example of a distance error that occurs due to the multipath phenomenon. In FIG. 4A, distance measurement values of the TOF device in the cases of occurrence and nonoccurrence of multipath are compared with each other. The horizontal axis indicates an actual distance L0 from the TOF device to a target object, and the vertical axis indicates values of measurement by the TOF device in the cases of occurrence of multipath (L2) and nonoccurrence of multipath (L1). The measurement value L1 in the case of nonoccurrence of multipath is equal to the actual distance L0 to the target object, but the measurement value L2 in the case of occurrence of multipath is larger than the actual distance L0.

In FIG. 4B, errors of the measurement values due to the multipath phenomenon are illustrated along the vertical axis. It can be found that the distance error (L2−L1) due to multipath is not constant but differs in accordance with the actual distance L0 from the TOF device to the target object. This means that the influence of the measurement environment (the degree of the reflection of the indirect light off the floor or wall) differs depending on the position of the target object.

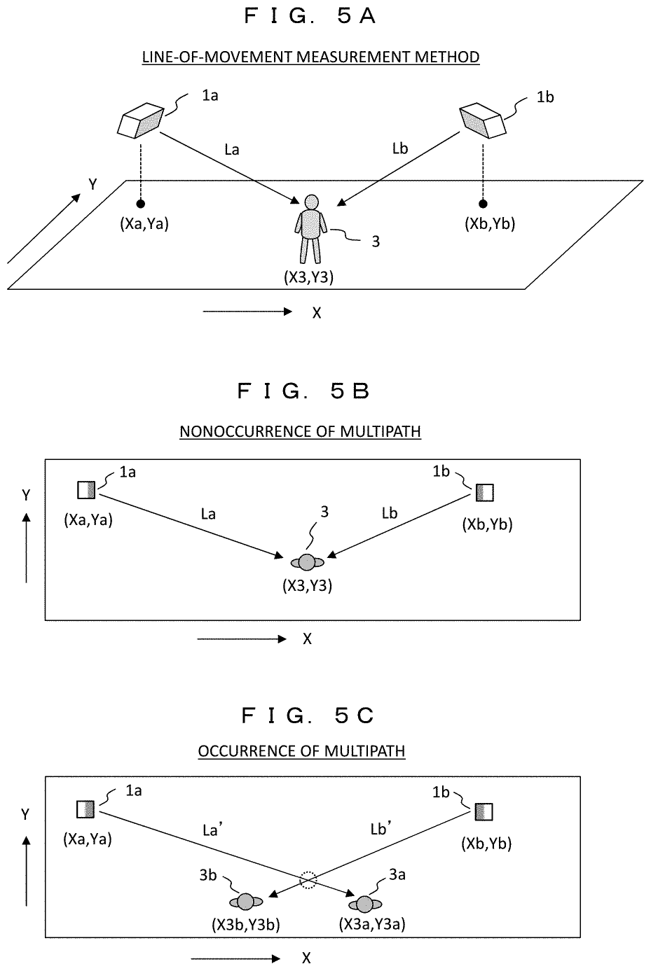

FIGS. 5A to 5C are figures for explaining influence of a distance error on line-of-movement measurement. It is supposed here that a plurality of the TOF devices are installed, and a travel route of a target object (person) in a room is determined. For example, in an environment where highly reflective marble is used for the surrounding wall or floor in an elevator hall, a problem that there are double lines of movement or the like occurs due to the multipath phenomenon.

FIG. 5A is a figure for explaining a method of line-of-movement measurement. In the case explained here, two TOF devices 1a and 1b are installed, and the line of movement of a person 3 is measured. Assuming that the installation position of the TOF device 1a is (Xa, Ya), and the installation position of the TOF device 1b is (Xb, Yb), it is supposed that the measurement values La and Lb of the distance to the person 3 are obtained by the TOF devices 1a and 1b, respectively. On the basis of the measurement values La and Lb, the positional coordinates (X3, Y3) of the person 3 are calculated.

FIG. 5B and FIG. 5C illustrate the position of the person 3 after being converted into a position in a plan view, on the basis of the measurement distances. FIG. 5B illustrates the case of nonoccurrence of multipath, and FIG. 5C illustrates the case of occurrence of multipath.

In the case of nonoccurrence of multipath in FIG. 5B, the position of the person 3 calculated by using the measurement value La of the TOF device 1a matches the position of the person 3 calculated by using the measurement value Lb of the TOF device 1b, and the positional coordinates (X3, Y3) are decided uniquely.

However, in the case of occurrence of multipath illustrated in FIG. 5C, errors are included in a measurement value La′ of the TOF device 1a, and a measurement value Lb′ of the TOF device 1b, and the distance is measured as being longer than the actual distance. That is, the positional coordinates (X3a, Y3a) of the person 3 calculated at the TOF device 1a, and the positional coordinates (X3b, Y3b) of the person 3 calculated at the TOF device 1b do not match. As a result, the coordinates of the single person are calculated as if there were different persons 3a and 3b, and the line of movement is split into two. Or, a problem occurs that the coordinates become discontinuous at the intersection between the measurement directions of the TOF devices la and 1b, and the line of movement is interrupted.

In order to cope with the multipath phenomenon like this, in the present embodiment, a TOF device is installed in an environment where measurement is to be performed, and a target object (sample) is placed at a predetermined distance in advance to perform measurement of the distance to the target object. Next, in a case where measurement distances are longer than the actual distance (true value), a correction formula to correct the measurement distances is created in accordance with distance errors that occur. The work up to this point is called a “preparatory step.” Then, in a case where a distance is measured actually by the TOF device, the distance measurement value is corrected by using the correction formula to reduce an error that occurs due to multipath. This work is called an “actual measurement step.”

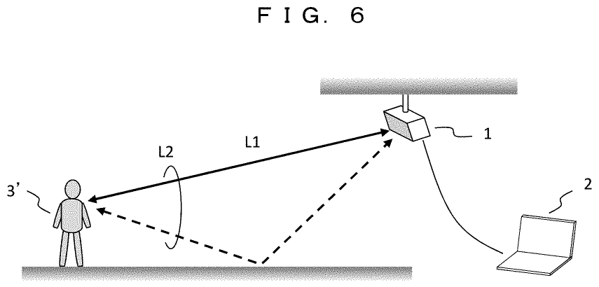

FIG. 6 is a figure for explaining a distance-error measurement method at the preparatory step. First, the TOF device 1 is installed in an actual usage environment. In this example, the TOF device 1 is attached to a ceiling. A measurement target object (sample) used at the preparatory step preferably has reflection characteristics similar to those of a measurement target object to be used at the actual measurement step, and here a person 3′ is used. The sample person 3′ stands at a position apart from the TOF device by a distance L1, and the TOF device 1 measures the distance to the person 3′, and obtains a measurement value L2.

Specifically, the position of the sample person 3′ is at the distance L1=2 to 8 m from the TOF device 1 at one-meter intervals, for example. Note that, by using a laser range finder or the like for checking the setting of the distance L1, it is possible to obtain the accurate distance L1 based only on direct light (solid line) not affected by multipath. On the other hand, the distance L2 is a measurement value based also on indirect light (broken line) affected by multipath.

After the TOF device 1 acquires the measurement value L2 of the distance to the person 3′ for each position (the distance L1) of the person 3′ in this manner, distance error calculations, and correction formula creation are performed on the basis of the data. Note that the correction formula creation can be performed by using the external processing device (personal computer) 2.

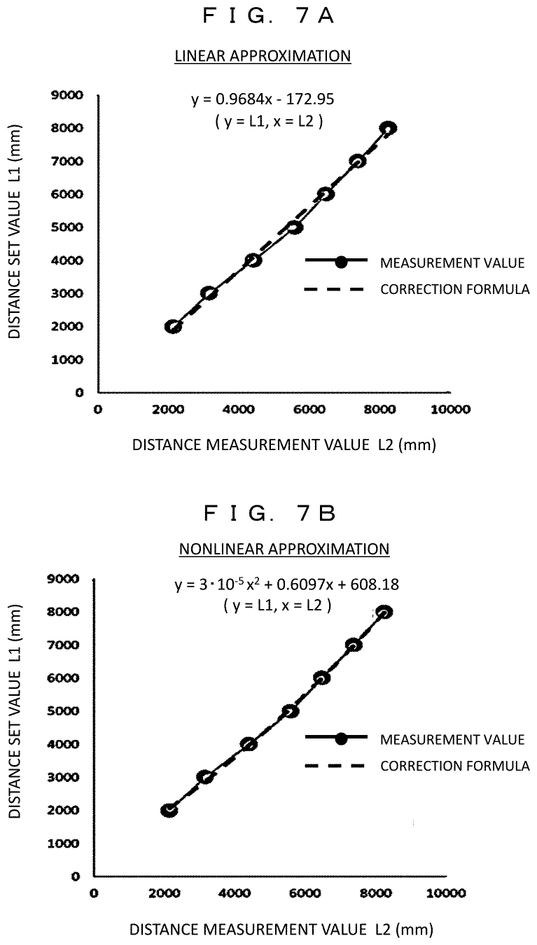

FIGS. 7A and 7B are figures for explaining an example of the creation of formulae for distance error correction. As approximation methods for correction, FIG. 7A illustrates linear approximation according to a linear formula, and FIG. 7B illustrates nonlinear approximation according to a quadratic formula. In either case, the distance set value L1 of the person 3′ explained with reference to FIG. 6 is plotted on the vertical axis (y-axis), and the distance measurement value L2 of the TOF device 1 corresponding to the distance set value L1 is plotted on the horizontal axis (x-axis). In the graphs, measurement points are indicated by the symbol ●, and solid lines link those symbols. By determining approximation formulae indicating a relationship between the value of L2 and the value of L1 in accordance with the least-squares method or the like, formulae for distance error correction as indicated by broken lines are obtained. In the correction formulae, L2 is defined as a variable x, and L1 is defined as a variable y.

FIG. 7A corresponds to the case where linear approximation is performed in accordance with a linear formula, and FIG. 7B corresponds to the case where nonlinear approximation is performed in accordance with a quadratic formula. Each of the figures illustrates an example of an approximation formula for correction in a corresponding case. Certainly, distance errors can be reduced further by using the quadratic formula in FIG. 7B as a correction formula. Approximation formulae are not limited to these, and may be polynomials of still higher degrees or formulae incorporating functions.

A correction formula created here, or coefficients of the correction formula is/are stored as the correction formula 16 in the TOF device 1 illustrated in FIG. 1. Then, the distance correcting section 15 uses the correction formula 16 to correct distance measurement values calculated at the distance computing section 14.

According to the correction method described above, a process of correcting distance errors that occur due to the multipath phenomenon can be performed more simply, and it becomes possible to perform the correction process with appropriate correction coefficients in accordance with the lengths of measurement distances.

Note that it is anticipated that the multipath phenomenon has different degrees of influence depending not only on the distance to a target object (person) but also on the direction (azimuth angle) of the target object as seen from the TOF device. Therefore, preferably, the distance error measurement illustrated in FIG. 6, and the correction formula creation illustrated in FIGS. 7A and 7B are implemented for a plurality of varied azimuth angles of the target object as seen from the TOF device, and correction formulae for the different azimuth angles are created. Then, the distance correcting section 15 performs correction by using different corresponding ones of correction formulae depending not only on measurement values of the distance to the target object but also on in which azimuth angles the target object is present, and thereby distance errors can be reduced further.

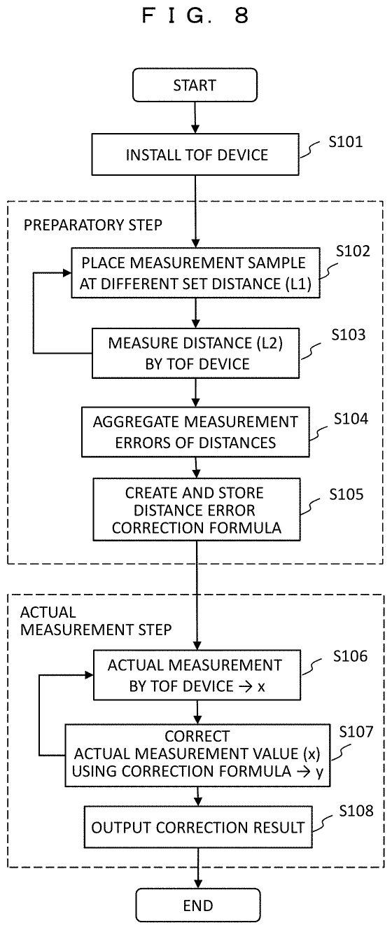

FIG. 8 is a flowchart illustrating a procedure of distance correction in the present embodiment. The distance correction in the present embodiment includes the preparatory step, and the actual measurement step.

S101: The TOF device 1 is installed at a measurement site. In the following, S102 to S105 are included in the preparatory step.

S102: A measurement-target-object sample (e.g. the person 3′) is placed apart from the TOF device 1 by the predetermined distance L1 (called the set value). The set value L1 is checked by using a laser range finder or the like. A plurality of values are determined in advance for the set value L1, and S102 and S103 are implemented by using those values in turn.

S103: The TOF device 1 measures the distance to the measurement sample placed at a distance equal to the set value L1, and an obtained measurement value is set as L2. Returning to S102, the set value L1 is changed, and S102 and S103 are repeated until they are completed for all the predetermined set values.

S104: From the relationship between the set value L1 of the measurement sample, and the measurement value L2 of the TOF device 1, measurement errors of the distances are aggregated.

S105: A formula for distance error correction, that is, the correction formula 16 for converting the measurement value L2 to the set value L1, is created, and stored on a memory of the distance correcting section 15. The preparatory step is completed here, and the process proceeds to the actual measurement step starting from S106.

S106: The TOF device 1 actually measures the distance to the target object, and sets the actual measurement value x to the measurement value. For example, in a case of line-of-movement measurement, the distance to a person at each time is measured.

S107: By using the correction formula 16, the distance correcting section 15 corrects the actual measurement value x obtained at S106, and calculates the corrected value y. Then, the process returns to S106, and S106 and S107 are repeated until a series of measurement is completed.

S108: The corrected distance data y is output. For example, the locus of line of movement of the person captured by the TOF device 1 or the like is output.

Although the explanation above is about one TOF device, in a case where a plurality of TOF devices are installed, the process is implemented for each TOF device.

In addition, the preparatory step from S102 to S105 in the flow described above is explained as being work to be performed by a user, this can also be automated. For example, while a target-object sample (travelling object) is moved, the set value L1 and the measurement value L2 are acquired automatically at each position, and coefficients for an approximation formula for correction can be automatically calculated from the relationship between the acquired set value L1 and measurement value L2.

According to the first embodiment, at the preparatory step, distance errors that occur due to the influence of multipath is determined in advance in an environment where the TOF device is installed, and a correction formula for correcting the distance errors is created. Therefore, the processing load of the TOF device for distance correction at the actual measurement step can be reduced significantly. Because the correction formula to be used at the time is the one that has been created in accordance with an actual measurement environment, for example, correction can be performed appropriately in accordance with the lengths of measurement distances; as a result, a distance measuring device with high measurement precision can be provided.

### Second Embodiment

In the first embodiment, the distance correcting section 15 that corrects distance data is included in the distance measuring device (TOF device) 1. In contrast, correction is performed by an external processing device in a second embodiment.

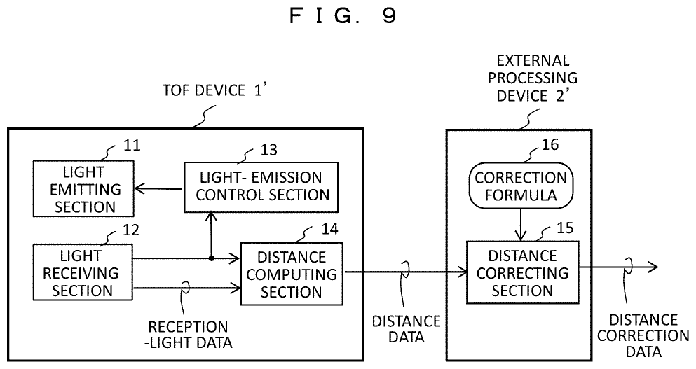

FIG. 9 is a figure illustrating the configuration of a distance measuring system according to the second embodiment. The distance measuring system includes a distance measuring device (TOF device) 1′, and an external processing device 2′. Although the TOF device 1′ includes the light emitting section 11, the light receiving section 12, the light-emission control section 13 and the distance computing section 14 similarly to the first embodiment (FIG. 1), the distance correcting section 15 and the correction formula 16 are moved to the external processing device 2′. That is, uncorrected distance data is output from the distance computing section 14 of the TOF device 1′ to the external processing device 2′, and the distance correcting section 15 of the external processing device 2′ corrects the distance data by using the correction formula 16. The creation of the correction formula 16 is similar to that in the first embodiment.

According to the configuration of the second embodiment, similarly to the first embodiment, it is possible to provide a distance measuring system that make it possible to significantly reduce the processing load for distance correction, and to appropriately correct measurement distances in accordance with the lengths of the measurement distances. In addition, the second embodiment allows for further size reduction and simplification of the TOF device 1′, and thus is suitable for a case where a large number of the TOF devices 1′ are used. On the other hand, by being connected with a plurality of TOF devices 1′, the external processing device 2′ can execute processes such as line-of-movement measurement using a plurality of pieces of distance data more efficiently.

What is claimed is:

1. A measurement-distance correction method for a distance measuring device that measures a distance to a target object on a basis of time of flight of light, the measurement-distance correction method comprising:
a preparatory step for correction including:
a step of placing a measurement sample such that a distance of the measurement sample from the distance measuring device becomes a set value L1;
a step of measuring a distance to the measurement sample by the distance measuring device, and obtaining a measurement value L2;
a step of acquiring the measurement value L2 corresponding to a plurality of values of the set value L1, while the set value L1 is changed to the plurality of values; and
a step of creating a correction formula for converting the measurement value L2 to the set value L1 on a basis of a relationship between the acquired set value L1 and measurement value L2; and
a step of actual measurement of a distance to the target object including:
a step of measuring the distance to the target object by the distance measuring device, and obtaining an actual measurement value x;
a step of correcting the actual measurement value x in accordance with the correction formula, and calculating a measurement-distance corrected value y; and
a step of outputting the corrected value y.

2. The measurement-distance correction method according to claim 1,
wherein the preparatory step further includes:
a step of placing the measurement sample at different azimuth angles as seen from the distance measuring device, and acquiring a relationship between the set value L1 and the measurement value L2 of a distance to the measurement sample at each different azimuth angle; and
a step of creating the correction formula for converting the measurement value L2 to the set value L1 for each azimuth angle on a basis of a relationship between the acquired set value L1 and measurement value L2, and
the actual measurement step includes:
a step of using the correction formula corresponding to an azimuth angle in which the target object is present, correcting the actual measurement value x, and calculating the corrected value y.

3. The measurement-distance correction method according to claim 1,
wherein the preparatory step includes:
a step of acquiring the set value L1 measured by using only direct light not affected by multipath, and the measurement value L2 measured by the distance measuring device at each movement position of the measurement sample while the measurement sample is moved, and of calculating a coefficient of the correction formula from a relationship between the acquired set value L1 and measurement value L2.

4. The measurement-distance correction method according to claim 1, wherein a nonlinear approximation formula is used as the correction formula created at the preparatory step.

5. A distance measuring device that measures a distance to a target object on a basis of time of flight of light, the distance measuring device comprising:
a light emitting section that emits irradiation light toward the target object;
a light receiving section that detects reflected light from the target object;
a light-emission control section that controls the light emitting section;
a distance computing section that calculates the distance to the target object on a basis of time of flight of the reflected light detected at the light receiving section; and
a distance correcting section that uses a correction formula, and corrects the distance calculated at the distance computing section,
wherein the correction formula is an approximation formula created in advance for converting a measurement value L2 to a set value L1 on a basis of a relationship between a plurality of values of the set value L1 and a plurality of values of the measurement value L2, the set value L1 being a distance of a measurement sample from the distance measuring device, the measurement value L2 being a measurement value of measurement of a distance to the measurement sample by the distance measuring device.

6. A distance measuring system comprising:
a distance measuring device that measures a distance to a target object on a basis of time of flight of light; and
an external processing device that corrects a measurement distance measured by the distance measuring device,
wherein the distance measuring device has:
a light emitting section that emits irradiation light toward the target object;
a light receiving section that detects reflected light from the target object;
a light-emission control section that controls the light emitting section; and
a distance computing section that calculates the distance to the target object on a basis of time of flight of the reflected light detected at the light receiving section; and
the external processing device has:
a distance correcting section that uses a correction formula, and corrects the distance calculated at the distance computing section of the distance measuring device,
wherein the correction formula is an approximation formula created in advance for converting a measurement value L2 to a set value L1 on a basis of a relationship between a plurality of values of the set value L1 and a plurality of values of the measurement value L2, the set value L1 being a distance of a measurement sample from the distance measuring device, the measurement value L2 being a measurement value of measurement of a distance to the measurement sample by the distance measuring device.
